(19) United States
(12) Patent Application Publication
(10) Pub. No.: US 2005/0141042 A1
(43) Pub. Date: Jun. 30, 2005

(54) Communication terminal device

(75) Inventors: Shinji Kawasaki, Joyo-shi (JP); Shigeki Takeuchi, Otsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/998,135

(22) Filed: Nov. 29, 2004

(30) Foreign Application Priority Data
Dec. 25, 2003 (JP) 2003-430753
Jan. 28, 2004 (JP) 2004-020072

(51) Int. Cl. G06F 15/00; G06F 15/16

(52) U.S. Cl. 358/402; 709/203

(57) ABSTRACT

A communication terminal device includes a registered information storage area, an address information acquiring unit, and a display unit. A directory server includes a database which stores address information including a plurality of attributes and item names of the attributes by associating to one another. From the database, the address information acquiring unit acquires the address information retrieved in accordance with the retrieval condition, and the item name. A correspondence table storage area stores a communication method and an item name by associating to one another. A detecting unit refers to the correspondence table storage area with the item name as the key and detects the attribute corresponding to the destination of the communication from the attributes included in the address information acquired by the address information acquiring unit. A display processing unit displays the attribute detected by the detecting unit.

### BACKGROUND OF THE INVENTION

1. Field of the Invention

The present invention relates to a communication terminal device, and particularly to a communication terminal device which acquires address information by using a directory service and carries out communication.

2. Description of the Related Art

Accompanying a spread of a network technology, for example, information equipments such as a facsimile machine and a Multi Functional Peripheral (MFP) are also connected to the network. Such a facsimile machine includes a general G3 facsimile communication function or the like. The facsimile machine also includes an electronic mail (e-mail) transmitting and receiving function, and an Internet facsimile function for transmitting and receiving image data of an original document or the like via the network such as a Local Area Network (LAN) and the Internet. The facsimile machine can carry out transmission and reception of information with another facsimile machine, a computer and an Internet facsimile machine or the like.

When transmitting a facsimile document to a prescribed destination by using a facsimile machine, a transmission document is scanned by the facsimile machine and a user dials a facsimile number of the destination. To simplify the dialing operation, many facsimile machines include a speed dial function and a telephone book function or the like.

As described above, by being connected to the network, the facsimile machine can fetch information accumulated in a directory server connected to the same network.

In a directory service based on a Lightweight Directory Access Protocol (LDAP), a known document file retrieval system executes a retrieval process based on the LDAP by a retrieval directory server from a client side and retrieves necessary information.

Conventionally, information such as a telephone book is stored in each facsimile machine. However, by registering the information such as the telephone book in the directory server, a unified management of the information such as the telephone book can be carried out.

However, the information such as the telephone book is stored not only in the directory server but also stored in the facsimile machine as speed dial numbers and the telephone book. As described above, it is convenient to acquire information by using the directory server. However, although there are cases in which the information is actually stored in the facsimile machine, the facsimile machine and the directory server were required to be operated separately.

For example, address information stored in the directory server includes a plurality of standard attributes such as a registrant name, a company name, a department name, a telephone number, a facsimile number and an e-mail address. Other than the standard attributes, a manager of the directory server can randomly register an extension attribute as an option. However, such an extension attribute is set randomly at the directory server. Therefore, the facsimile machine cannot grasp the extension attribute registered with the directory server. Thus, conventionally, even when an extension telephone number or a mobile phone number or the like is included in the extension attribute of the address information of the retrieval result, such information cannot be recognized as the address information and could not be displayed as the telephone number.

### SUMMARY OF THE INVENTION

An advantage of the present invention is to provide a communication terminal device which can use both information of a directory server and the communication terminal device and efficiently acquire address information of a destination.

Another advantage of the present invention is to provide a communication terminal device which can appropriately detect a destination of communication by a communication method from address information when the address information is acquired by using a directory server.

According to an aspect of the present invention, a communication terminal device includes a storage unit which stores address information. The communication terminal device further includes an accepting unit, an acquiring unit, a retrieving unit and a notification unit. The accepting unit accepts a retrieval condition for inquiring the address information. The acquiring unit acquires from a directory server having a database which stores the address information, address information retrieved in accordance with the retrieval condition. The retrieving unit detects from the address information stored in the storage unit, address information corresponding to the retrieval condition. The notification unit notifies at the same time, the address information acquired by the acquiring unit and the address information detected by the retrieving unit.

According to the present invention, to acquire address information of a destination, the communication terminal device can inquire the directory server and can also retrieve the information stored in the storage unit of the communication terminal device. Accordingly, by using both of the information stored in the directory server and the storage unit of the communication terminal device, the address information of the destination can be acquired efficiently.

In the above-described communication terminal device, the acquiring unit can acquire the address information by associating to identification information which specifies the directory server that provided the address information. The notification unit can notify the address information along with the identification information indicating a provider of each address information.

The communication terminal device further includes a detecting unit which detects a degree of reliability of the address information acquired by the acquiring unit and the address information detected by the detecting unit. The notification unit can notify the address information along with the degree of the reliability.

The detection of the degree of the reliability of the address information by the detecting unit can be carried out by preparing and referencing a management table. Further, the management table defines reliability of the provider of the address information. The communication terminal device can include an updating unit which analyzes a communication result of the provided address information for each provider, calculates the reliability of the provider and updates the management table. The detecting unit can register a communication record, and a record of a date and time of update when address information is newly registered or changed. In accordance with the records, the detecting unit can detect the degree of reliability of the address information.

According to the aspect of the present invention, the communication terminal device can notify the user as to the address information acquired by the retrieval process and the degree of the reliability of the address information. Accordingly, even when a plurality of address information is acquired redundantly for one destination, the user can easily determine which address information is to be used. As a result, usability of the communication terminal device improves.

According to an, aspect of the present invention, a communication terminal device can carry out communication under a plurality of communication methods. The communication terminal device includes an accepting unit, an acquiring unit, a detecting unit and a notification unit. The accepting unit accepts a retrieval condition. A database stores address information including a plurality of attributes and item names of the attributes by associating to one another. From the database, the acquiring unit acquires the address information retrieved in accordance with the retrieval condition, and the item name. The detecting unit detects from the plurality of the attributes in accordance with the item name, an attribute corresponding to a destination of communication by the communication method. The notification unit notifies the attribute detected by the detecting unit and the address information by associating the attribute with the communication method.

The database can be provided in a directory server. The communication method includes telephone or facsimile communication using a Public Switched Telephone Network (PSTN), telephone or facsimile communication using the Internet, mail communication, an access to a Uniform Resource Locator (URL), an access to a File Transfer Protocol (FTP) server and an access to a shared folder or the like.

According to the aspect of the present invention, from the plurality of the attributes included in the address information, in accordance with an item name associated with each attribute, the communication terminal device detects the attribute which is to be the destination of the communication by the communication method and notifies the user. Therefore, the user can grasp the destination and the communication method by associating to one another. Accordingly, information can be utilized effectively. As a result, convenience of the user improves. The attribute includes a telephone number, a facsimile number and an e-mail address or the like.

The item name stored in the database can be set by the manager of the database.

The communication terminal device can further includes a storage unit which stores the communication method and the item name by associating to one another. The detecting unit can refer to the storage unit and detect an attribute corresponding to the destination of the communication by the communication method from the plurality of the attributes. With the item name associated to the address information acquired from the database as the key, the detecting unit refers to the storage unit and associates the communication method and the attribute.

In the above-described communication terminal device, the detecting unit can detect the attribute corresponding to the destination of the communication by the communication method from the plurality of the attributes in accordance with a feature of the item name acquired by the acquiring unit. The feature of the item name can be a character string included in the item name. For example, when the item name includes a character string of “telephone”, the detecting unit can detect that the communication method of the attribute corresponding to the item name is “telephone”.

Further, any combinations of the above-described constituent elements and the conversions of the expression of the present invention between a method, a device, a system, a recording medium, a computer program or the like are also effective as an embodiment of the present invention.

As described above, according to the present invention, the communication terminal device can use both of the information in the directory server and the communication terminal device and efficiently acquire the address information of the destination.

According to the present invention, when acquiring the address information by using the directory server, the communication terminal device can appropriately detect the destination of the communication by the communication method from the address information.

### BRIEF DESCRIPTION OF THE DRAWINGS

FIG. 1 is a block diagram showing a network configuration of a communication terminal device according to a first embodiment of the present invention.

FIG. 2 is a functional block diagram of a control unit of the communication terminal device of FIG. 1.

FIG. 3 is a flowchart showing an operation of the communication terminal device of FIG. 1.

FIG. 4 shows an example of a display of a retrieval result of the communication terminal device of FIG. 1.

FIG. 5 is a functional block diagram of a control unit of a communication terminal device according to a second embodiment of the present invention.

FIG. 6A through FIG. 6C show examples of management tables used in the communication terminal device of FIG. 5.

FIG. 7 is a flowchart showing an operation of the communication terminal device of FIG. 5.

FIG. 8 shows an example of a display of a retrieval result of the communication terminal device of FIG. 5.

FIG. 9 is a block diagram showing a network configuration of a communication terminal device according to a third embodiment of the present invention.

FIG. 10 is a functional block diagram of a control unit of the communication terminal device of FIG. 9.

FIG. 11A through FIG. 11C show examples of correspondence tables of the communication terminal device of FIG. 9.

FIG. 12 is a flowchart showing an operation of the communication terminal device of FIG. 9.

FIG. 13A and FIG. 13B show examples of displays of retrieval results of the communication terminal device of FIG. 9.

### DETAILED DESCRIPTION OF THE PREFERRED EMBODIMENTS

Embodiments of the present invention will be described with reference to the drawings.

### First Embodiment

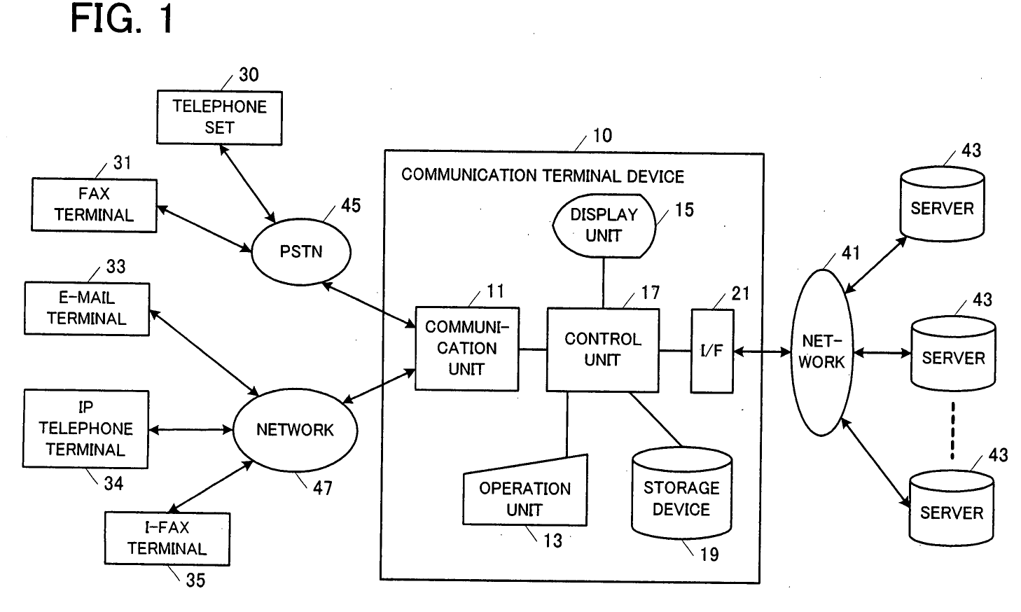

FIG. 1 is a block diagram showing a network configuration of a communication terminal device according to a first embodiment of the present invention. A communication terminal device 10 is connected to a plurality of directory servers 43 via a network 41. Each of the directory servers 43 includes a database (not shown) in which various pieces of information are accumulated. The communication terminal device 10 inquires to the directory servers 43 and acquires information. For example, by using a directory service based on the LDAP, a retrieval process based on the LDAP is executed by the directory servers 43 and the communication terminal device 10 acquires information.

In the first embodiment, the database of the directory servers 43 stores address information including a plurality of items regarding a plurality of registrants. To acquire the address information of a destination, the communication terminal device 10 inquires to the directory servers 43. The retrieval process is executed by the directory servers 43 and corresponding information is acquired from the registrants.

The communication terminal device 10 can carry out communication with other communication terminal devices by a plurality of communication methods. For example, the communication terminal device 10 carries out communication with a telephone set 30 and a facsimile terminal 31 through a PSTN 45. The communication terminal device 10 also carries out communication with an e-mail terminal 33, an Internet Protocol (IP) telephone terminal 34 and an Internet facsimile terminal 35 through a network 47 such as the Internet.

Although not shown in the drawing, the communication terminal device 10 can also carry out communication with a mobile phone terminal. In this case, the communication terminal device 10 carries out the communication via a wireless base station and a wireless relay station.

When the communication terminal device 10 carries out communication with other communication terminal devices, the communication terminal device 10 designates the address information of the destination. The address information of the destination differs according to each type of communication terminal device. For example, the address information of the destination includes a telephone number, a facsimile number, an e-mail address, an IP telephone number and an Internet facsimile number.

The communication terminal device 10 includes a communication unit 11, an operation unit 13, a display unit 15, a control unit 17, a storage device 19 and an interface unit 21. For example, the communication terminal device 10 is a network facsimile machine or an MFP. Further, in FIG. 1, a configuration unrelated to essential parts of the present invention is omitted. For example, a document scanning unit, an image processing unit and a printing unit of a facsimile machine, and a voice output unit, a sound collector and a voice processing unit of a telephone device are not shown.

Each of constituent elements of the communication terminal device 10 is realized by any combination of hardware and software primarily by a Central Processing Unit (CPU) of any computer, a memory, a program which is loaded in the memory and implements the constituent elements shown in FIG. 1, a storage unit such as a hard disk for storing the program and an interface for a network connection or the like. It is to be understood by those skilled in the art that there are variations to the methods and the devices for implementing each of the constituent elements of the communication terminal device 10. Each of the drawings to be described hereinafter shows blocks representing units of function, instead of units of hardware.

The communication unit 11 carries out communication with the telephone set 30, the facsimile terminal 31, the e-mail terminal 33, the IP telephone terminal 34 and the Internet facsimile terminal 35.

The operation unit 13 accepts various settings and inputs made by a user of the communication terminal device 10. For example, the operation unit 13 includes an operation button, a switch, a lever, a keyboard and a touch panel.

The display unit 15 displays various pieces of information, an operation screen and an operational status of the communication terminal device 10. For example, the display unit 15 is a lamp, a Light Emitting Diode (LED), a Cathode Ray Tube (CRT) monitor, a Liquid Crystal Display (LCD) or the like.

The control unit 17 controls various elements of the communication terminal device 10 and the entire communication terminal device 10.

The storage device 19 includes an acquired information storage area and a registered information storage area. The acquired information storage area temporarily stores a retrieval result acquired from the directory servers 43. The registered information storage area stores address information such as a telephone book stored in the directory servers 43. The storage areas will be described in detail later.

The interface unit 21 enables the communication terminal device 10 to carry out communication with the plurality of the directory servers 43 connected via the network 41.

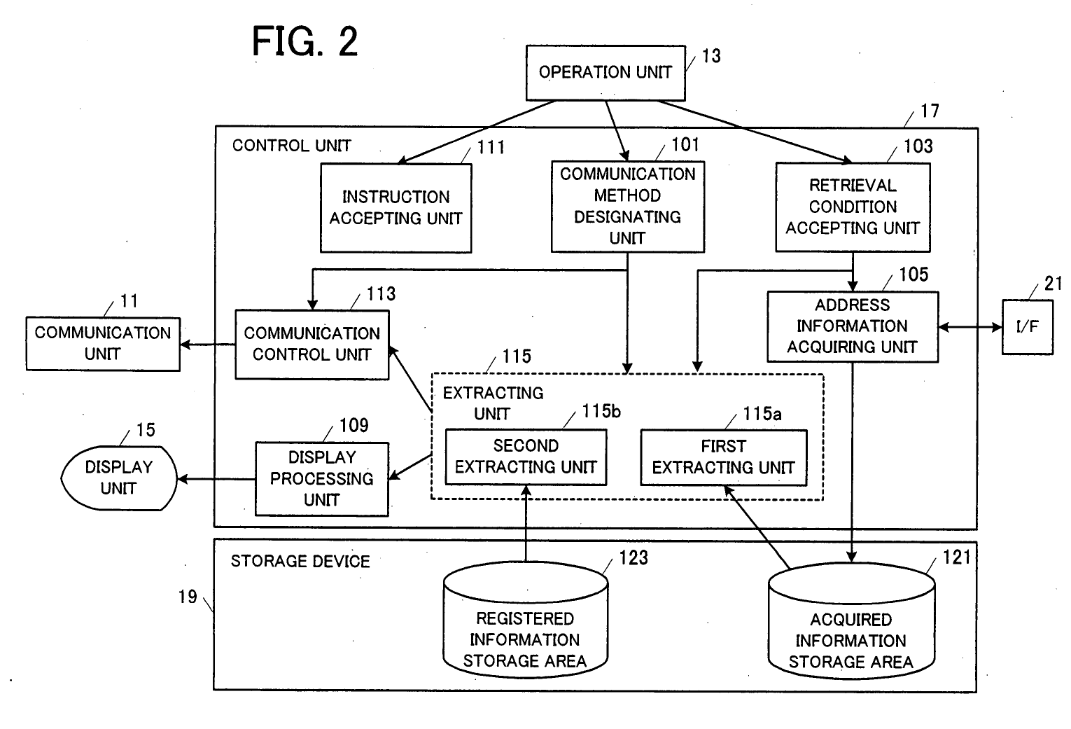

FIG. 2 is a functional block diagram showing the control unit 17 of the communication terminal device 10 in detail. The control unit 17 includes a communication method designating unit 101, a retrieval condition accepting unit 103, an address information acquiring unit 105, a first extracting unit 115a, a second extracting unit 115b, a display processing unit 109, an instruction accepting unit 111 and a communication control unit 113. The storage device 19 includes an acquired information storage area 121 and a registered information storage area 123.

The communication method designating unit 101 designates a communication method to be used for the communication. For example, in case of transmitting the information to the facsimile terminal 31, the communication method designating unit 101 designates facsimile communication using the PSTN as the communication method. In case of transmitting the information to the e-mail terminal 33, the communication method designating unit 101 designates e-mail communication as the communication method. In case of transmitting the information to the Internet facsimile terminal 35, the communication method designating unit 101 designates IP facsimile communication as the communication method.

The retrieval condition accepting unit 103 accepts from the user, an input of a retrieval condition for inquiring the address information.

The address information acquiring unit 105 inquires the directory server 43, which includes the database storing a plurality of address information, as to the address information in accordance with the retrieval condition. The address information acquiring unit 105 acquires the address information of the retrieval result returned from the directory server 43. In this case, the address information acquiring unit 105 acquires the address information by associating with identification information of the directory server 43 that provided the address information. The address information acquiring unit 105 stores the acquired address information and the identification information of the directory server 43 in the acquired information storage area 121 of the storage device 19.

An extracting unit 115 includes the first extracting unit 115a and the second extracting unit 115b. The first extracting unit 115a carries out an extracting process of the information acquired from the directory server 43. The second extracting unit 115b carries out an extracting process of the information of the registered information storage area 123 of the storage device 19. The first extracting unit 115a extracts from the address information stored in the acquired information storage area 121, address information suitable for the communication method designated by the communication method designating unit 101. The second extracting unit 115b retrieves the address information stored in the registered information storage area 123 in accordance with the retrieval condition accepted by the retrieval condition accepting unit 103. The second extracting unit 115b extracts from the retrieved address information, address information suitable for the communication method designated by the communication method designating unit 101.

The display processing unit 109 carries out a processing for displaying various pieces of information on the display unit 15. The instruction accepting unit 111 accepts various instructions from the user and notifies the accepted instruction to a corresponding unit. The communication control unit 113 controls the communication carried out by the communication unit 11 in accordance with the instruction accepted by the instruction accepting unit 111 and the communication method designated by the communication method designating unit 101.

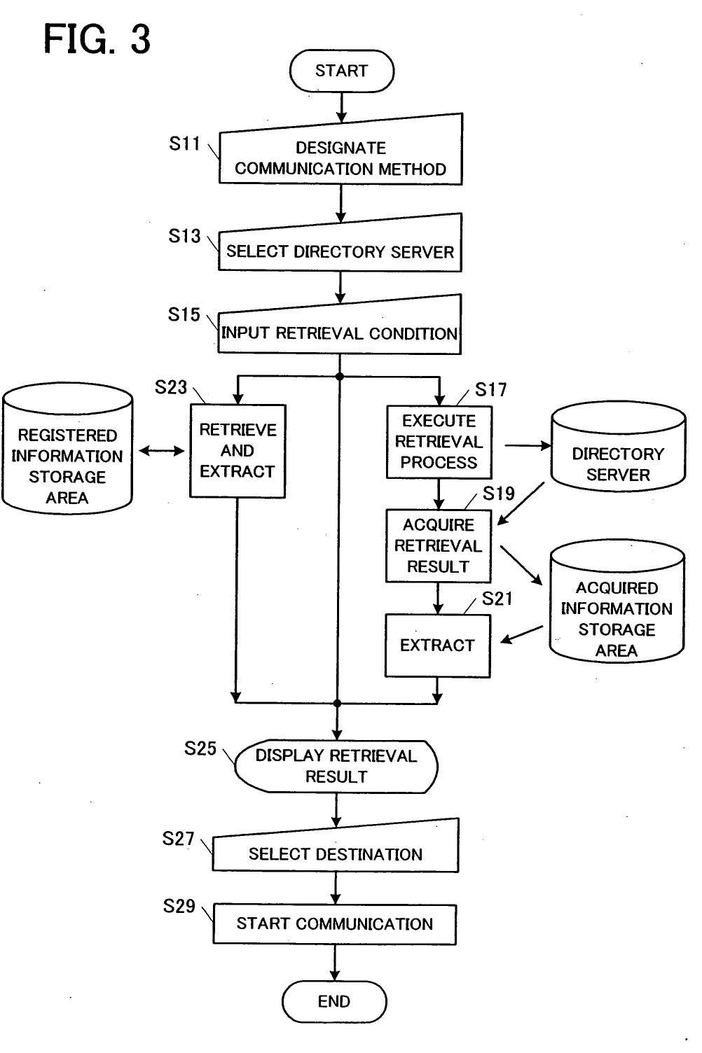

An operation of the above-described communication terminal device 10 will be described below. FIG. 3 is a flowchart showing the operation of the communication terminal device 10.

First, the communication method designating unit 101 designates at least one communication method to be used for the communication from a plurality of communication methods (step S11).

Next, at least one directory server is selected for carrying out the retrieval process (step S13). Specifically, first, the display unit 15 displays a selection screen for selecting the directory server 43. The user refers to the selection screen and selects a directory server 43. The instruction accepting unit 111 accepts an instruction of the user and notifies to the address information acquiring unit 105. Further, this step can be omitted. For example, the directory server 43 for carrying out the retrieval process can be set previously. Moreover, an appropriate directory server 43 can be selected automatically by the address information acquiring unit 105. Alternatively, an inquiry can be carried out at the same time or sequentially to the plurality of the directory servers 43.

Next, a retrieval condition is input (step S15). When the user inputs at least a part of a name of the destination, the retrieval condition accepting unit 103 accepts the part of the name of the destination as the retrieval condition.

Then, the retrieval process is executed (step S17). The directory server 43 retrieves the address information in accordance with the retrieval condition. The address information acquiring unit 105 acquires the retrieval result via the interface unit 21 (step S19). The address information acquiring unit 105 acquires the retrieval result by associating to the identification information of the directory server 43 that provided the acquired retrieval result. The address information acquiring unit 105 stores the acquired retrieval result and the identification information along with the address information in the acquired information storage area 121.

Next, the first extracting unit 115a extracts from the acquired information stored in the acquired information storage area 121, only the address information suitable to the communication method designated at step S11 (step S21).

Meanwhile, in parallel with step S17, the second extracting unit 115b carries out a retrieval process in accordance with the retrieval condition accepted at step S15 from the registered information stored in the registered information storage area 123. The second extracting unit 115b extracts only the address information suitable to the communication method designated at step S11 (step S23).

The display processing unit 109 displays on the display unit 15 as the retrieval result, the address information extracted at steps S21 and S23 along with the identification information indicating a provider of the address information (step S25).

Next, a destination is selected from the displayed retrieval result (step S27). The user can select a destination by referring to the retrieval result displayed on the display unit 15. The instruction accepting unit 111 accepts a selection of the user and notifies the address information of the accepted destination to the communication control unit 113. Then, when the user instructs a start of the communication, the communication starts (step S29).

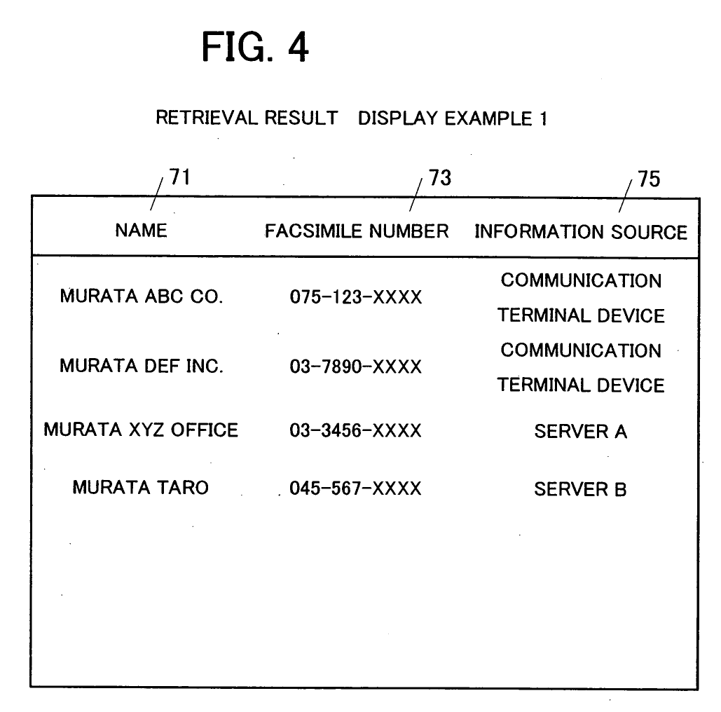

FIG. 4 shows an example of a display of the extracted retrieval result. As the retrieval result, a name 71 of the destination, the address information of the destination, here, a facsimile number 73, and an information source 75 indicating the provider of the address information are displayed. In a column of the information source 75, the identification information given at step S27 is displayed.

As described above, according to the communication terminal device 10 of the first embodiment, by using both of the information stored in the directory server 43 and the storage device 19, the address information of the destination can be acquired efficiently.

### Second Embodiment

In the second embodiment, the communication terminal device 10 also has the same network configuration as the configuration described with reference to FIG. 1 in the first embodiment. In the second embodiment, the communication terminal device 10 can detect a degree of reliability of the acquired address information.

The degree of reliability is determined according to, for example, reliability of the provider of the address information, a newest communication record including a communication result of the address information or an update record of newly registered or changed address information or the like. A provider having a higher success rate of the communication of the provided address information has higher reliability. The address information having a communication result in the communication record has higher reliability. Alternatively, the address information having a record of a communication failure in the communication record has lower reliability. The address information having a newer date and time of update of a new registration or a change of the address information in the update record has higher reliability.

When a plurality of different address information is acquired redundantly from a plurality of different providers for one destination, the communication terminal device 10 notifies the address information to the user in a descending order of reliability.

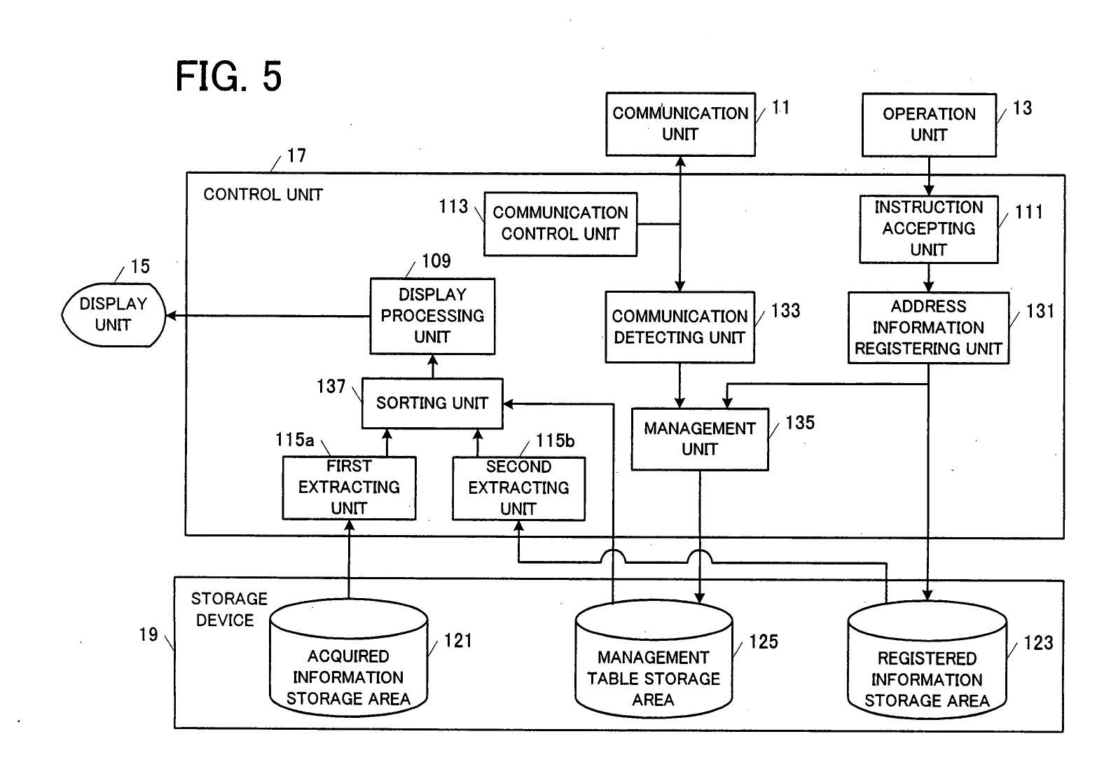

FIG. 5 is a functional block diagram showing the control unit 17 of the communication terminal device 10 according to the second embodiment. The control unit 17 includes an address information registering unit 131, a communication detecting unit 133, a management unit 135 and a sorting unit 137. The storage device 19 includes a management table storage area 125. Although not shown in the drawing, the control unit 17 also includes the communication method designating unit 101, the retrieval condition accepting unit 103 and the address information acquiring unit 105 as described in FIG. 2.

In the second embodiment, the instruction accepting unit 111 accepts an instruction from the user such as a new registration, a deletion and a change of the address information. According to the instruction of the new registration of the address information accepted by the instruction accepting unit 111, the address information registering unit 131 stores the newly registered address information in the registered information storage area 123. According to the instruction of the change of the address information accepted by the instruction accepting unit 111, the address information registering unit 131 changes corresponding address information stored in the registered information storage area 123. Furthermore, the address information registering unit 131 notifies to the management unit 135, the registered and the changed address information and the date and time of the update.

The communication detecting unit 133 detects the date and time of the communication carried out by the communication control unit 113 and communication status. The communication detecting unit 133 notifies the corresponding address information, the communication status and the date and time of the communication to the management unit 135. The management unit 135 records in a management table, information such as the address information and the date and time received from the address information registering unit 131 and the communication detecting unit 133. Then, the management unit 135 stores the management table in the management table storage area 125.

The sorting unit 137 refers to the management table of the management table storage area 125 and sorts the address information extracted by the extracting unit 115 in the descending order of reliability.

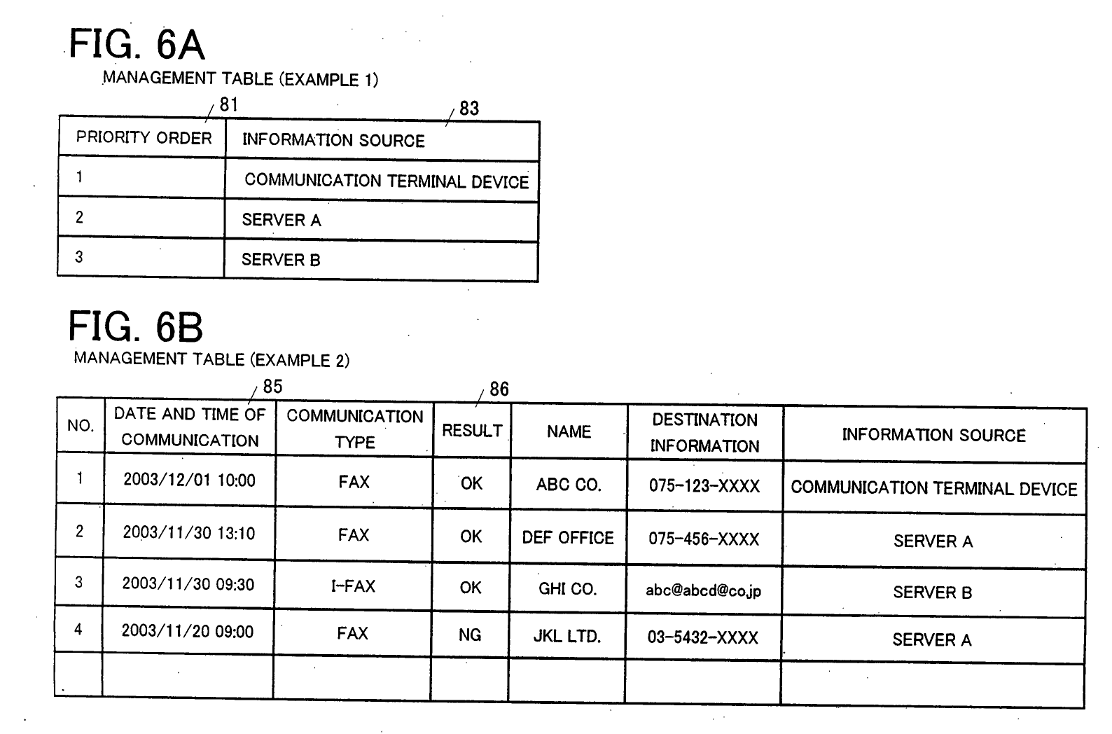

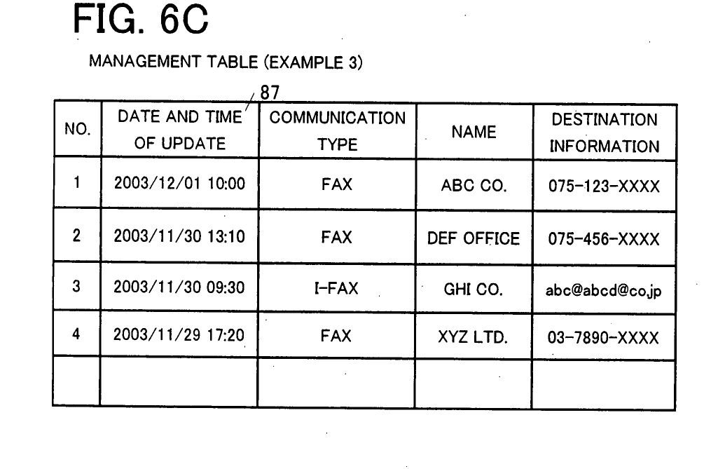

The management table storage area 125 stores the management table for managing the information to be used for detecting the degree of reliability of the address information extracted by the extracting unit 115. FIG. 6A through FIG. 6C show examples of the management table stored in the management table storage area 125.

The management table of FIG. 6A defines a priority order 81 of the identification information indicating the providers of the address information. The provider of the address information with higher reliability is defined in a higher priority order. The management table shown in FIG. 6A is used when sorting the address information according to the reliability of the provider of the information.

In the drawing, a “communication terminal device” written in a column of an information source 83 indicates the storage device 19 of the communication terminal device 10. A “server A” and a “server B” respectively indicate two different directory servers 43 by an abbreviated name. Here, since the reliability of the address information stored in the storage device 19 is the highest, the priority order 81 of the “communication terminal device” is ranked first.

The management table of FIG. 6B is a newest communication record of the address information, and a date and time of communication 85 and a result 86 or the like are recorded.

The management table of FIG. 6C is an update record of the address information stored in the registered information storage area 123 of the storage device 19, and a date and time of update 87 of the address information is recorded.

In the examples of FIG. 6B and FIG. 6C, the same management table is used for all of the communication methods. However, the management table is not limited to these examples. A management table can be provided for each of the communication methods.

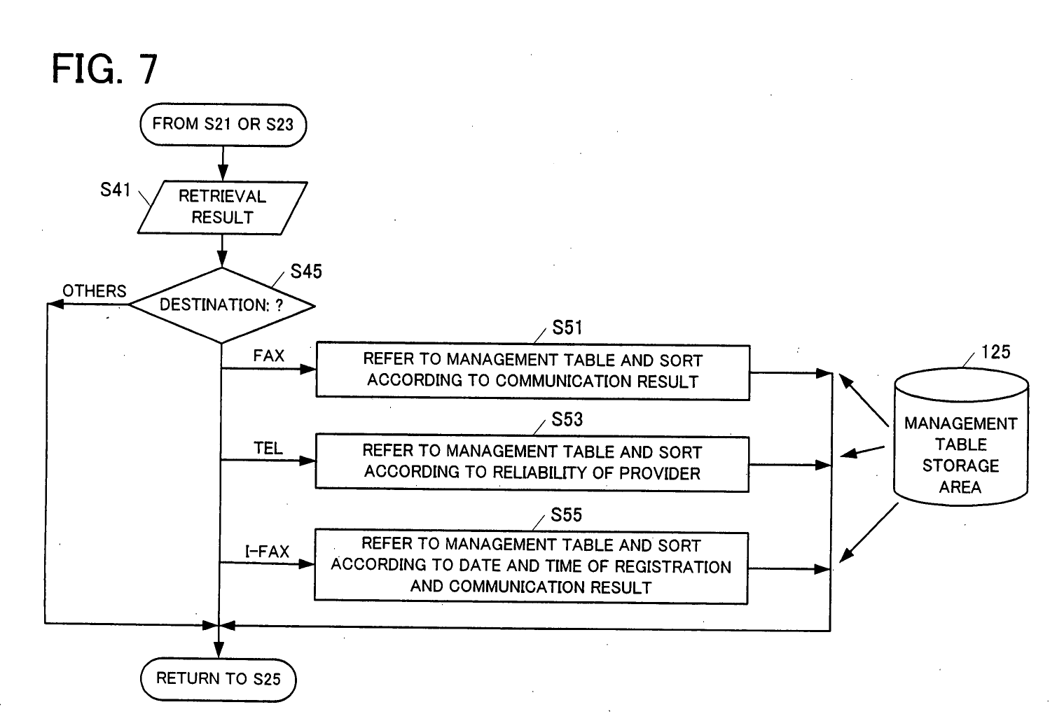

An operation of the above-described communication terminal device 10 will be described. FIG. 7 is a flowchart showing an operation of the communication terminal device according to the present embodiment.

First, the sorting unit 137 receives the address information extracted from the extracting unit 115 (step S41). According to a destination of the address information received at step S41, the process is diverged (step S45). In either case, the management table stored in the management table storage area 125 is referenced, and in accordance with the management table, the address information is sorted.

In case the destination is a facsimile number (FAX at step S45), by using the management table shown in FIG. 6B, the address information is sorted according to the communication result (step S51). In case the destination is a telephone number (TEL at step S45), by using the management table shown in FIG. 6A, the address information is sorted according to the reliability of the provider of the information (step S53). In case the destination is an Internet facsimile number (I-FAX at step S45), by using the management tables shown in FIG. 6B and FIG. 6C, the address information is stored in a reverse chronological order of the date and time of the registration and the date and time of the communication (step S55).

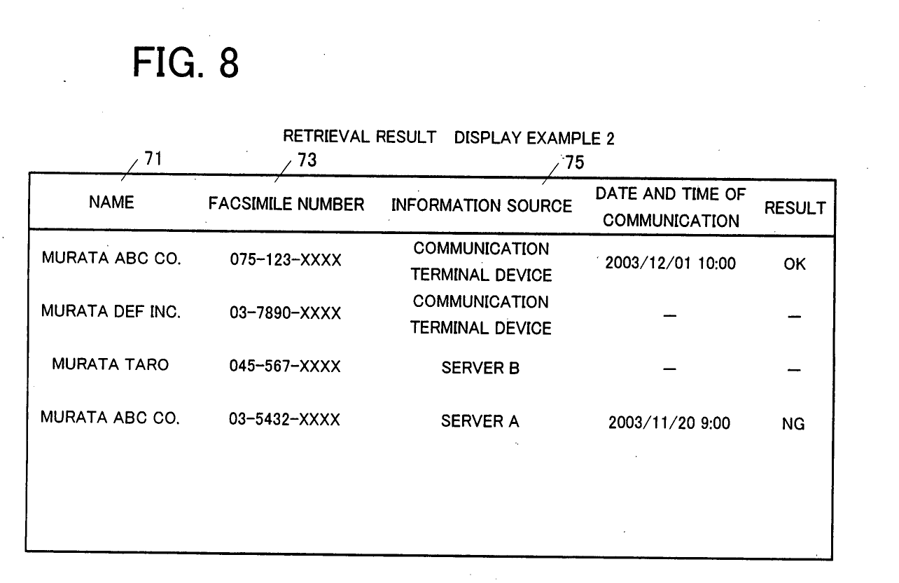

The sorted address information is displayed on the display unit 15 by the display processing unit 109 as shown in the example of FIG. 8.

As described above, the communication terminal device 10 can sort the address information acquired by the retrieval process in the descending order of reliability and notify to the user. Accordingly, even when a plurality of address information is acquired redundantly for one destination, the user can easily determine which address information is to be used. As a result, usability of the communication terminal device 10 improves.

The preferred embodiments of the present invention have been described. However, the present invention is not limited to the above-described embodiments. It is to be understood by those skilled in the art that there are variations to the present invention without departing from the scope of the present invention.

Further, the address information which can be designated as the destination by the communication terminal device 10 can also include a URL, an FTP path and a path of a shared folder or the like, other than the abovementioned telephone number, the facsimile number and the e-mail address or the like.

The processes of the flowchart of FIG. 7 can be omitted when the extracted result does not include redundant address information of the destination.

Further, the processes of steps S51 through S55 of FIG. 7 for detecting the degree of reliability for each destination are not limited to the above-described example. For example, for the detection of the degree of reliability, different management tables can be used for each destination, or the same management table can be used for a plurality of destinations. For the detection of the degree of reliability, a plurality of management tables can be used together. In the above-described example, the address information is sorted in the descending order of priority and displayed on the display unit 15. However, the present invention is not limited to this example. As another example, information indicating the degree of reliability can be displayed on the display unit 15 along with the retrieval result. Alternatively, only the information with high reliability can be selected and displayed on the display unit 15.

The communication terminal device 10 can include an updating unit (not shown) which analyzes the communication result of the provided address information for each provider, calculates the reliability of the provider and updates the management table.

### Third Embodiment

In the third embodiment, when acquiring the address information by using the directory server, the communication terminal device can detect an extension attribute set randomly in the address information at the directory server.

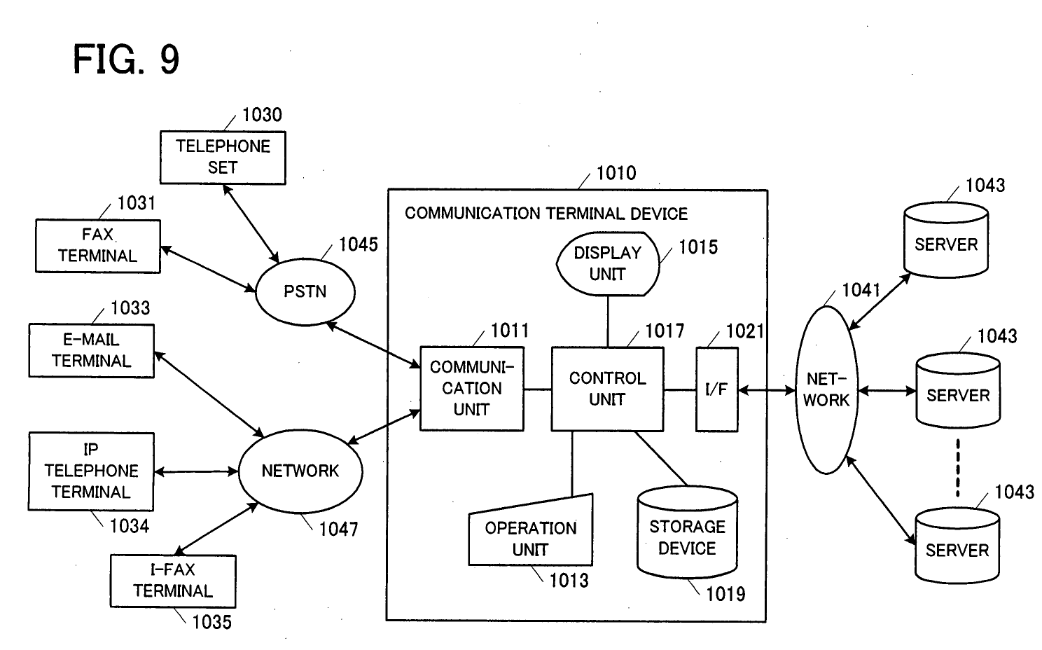

The third embodiment of the present invention will be described with reference to the drawings. FIG. 9 is a block diagram showing a network configuration of the communication terminal device according to the third embodiment. A communication terminal device 1010 is connected to a plurality of directory servers 1043 via a network 1041. Each of the directory servers 1043 includes a database (not shown) in which various pieces of information are accumulated. The communication terminal device 1010 transmits a retrieval condition to the directory server 1043. A retrieval process is executed by the directory server 1043. The communication terminal device 1010 acquires the retrieval result from the directory server 1043. For example, by using a directory service based on the LDAP, the communication terminal device 1010 executes the retrieval process based on the LDAP by the directory server 1043.

In third embodiment, the database of the directory server 1043 stores address information having a plurality of attributes for a plurality of registrants. For example, the attributes include basic attributes such as a registrant name, a company name, a department name, a telephone number, a facsimile number and an e-mail address, and extension attributes such as an extension telephone number, an extension facsimile number and a mobile phone number. The extension attributes are attributes set by a manager of the directory server 1043. Each of the attributes is stored by being associated to an item name of the attribute. A data structure of the directory server 1043 will be described later. In the present embodiment, for acquiring the address information of the destination, the communication terminal device 1010 inquires to the directory server 1043.

The communication terminal device 1010 can carry out communication with other communication terminal devices under a plurality of communication methods. For example, the communication terminal device 1010 carries out communication with a telephone set 1030 and a facsimile terminal 1031 through a PSTN 1045. The communication terminal device 1010 carries out communication with an e-mail terminal 1033, an IP telephone terminal 1034 and an Internet facsimile terminal 1035 through a network 1047 such as the Internet.

Although not shown in the drawing, the communication terminal device 1010 can carry out communication with a mobile phone terminal. In this case, the communication terminal device 1010 carries out the communication via a wireless base station and a wireless relay station.

The communication terminal device 1010 includes a communication unit 1011, an operation unit 1013, a display unit 1015, a control unit 1017, a storage device 1019 and an interface unit 1021. For example, the communication terminal device 1010 is a network facsimile machine or a MFP. Further, in FIG. 9, a configuration unrelated to essential parts of the present invention is omitted. For example, a document scanning unit, an image processing unit and a printing unit of a facsimile machine, and a voice output unit, a sound collector and a voice processing unit of a telephone device are not shown.

Each of constituent elements of the communication terminal device 1010 is realized by any combination of hardware and software primarily by a CPU of any computer, a memory, a program which is loaded in the memory and implements the constituent elements shown in FIG. 9, a storage unit such as a hard disk for storing the program and an interface for a network connection or the like. It is to be understood by those skilled in the art that there are variations to the methods and the devices for implementing each of the constituent elements of the communication terminal device 1010. Each of the drawings to be described hereinafter shows blocks representing units of function, instead of units of hardware.

The communication unit 1011 carries out communication with the telephone set 1030, the facsimile terminal 1031, the e-mail terminal 1033, the IP telephone terminal 1034 and the Internet facsimile terminal 1035 or the like. The operation unit 1013 accepts various settings and inputs made by a user of the communication terminal device 1010. For example, the operation unit 1013 includes an operation button, a switch, a lever, a keyboard and a touch panel. The display unit 1015 displays various pieces of information, an operation screen and an operational status of the communication terminal device 1010. For example, the display unit 1015 is a lamp, an LED, a CRT monitor, a LCD or the like.

The control unit 1017 controls various elements of the communication terminal device 1010 and the entire communication terminal device 1010. The storage device 1019 has a retrieval result storage area for temporarily storing the retrieval result acquired from the directory servers 1043. The storage device 1019 also has a correspondence table storage area for storing a table which associates an item name of the attribute of the address information and the communication method. The correspondence table will be described in detail later.

The interface unit 1021 carries out communication with the plurality of the directory servers 1043 connected via the network 1041. Further, in FIG. 9, the communication via the network 1041 is carried out by the interface unit 1021, and the communication via the network 1047 is carried out by the communication unit 1011. However, the present invention is not limited to this example. The communication can be carried out by the same interface unit.

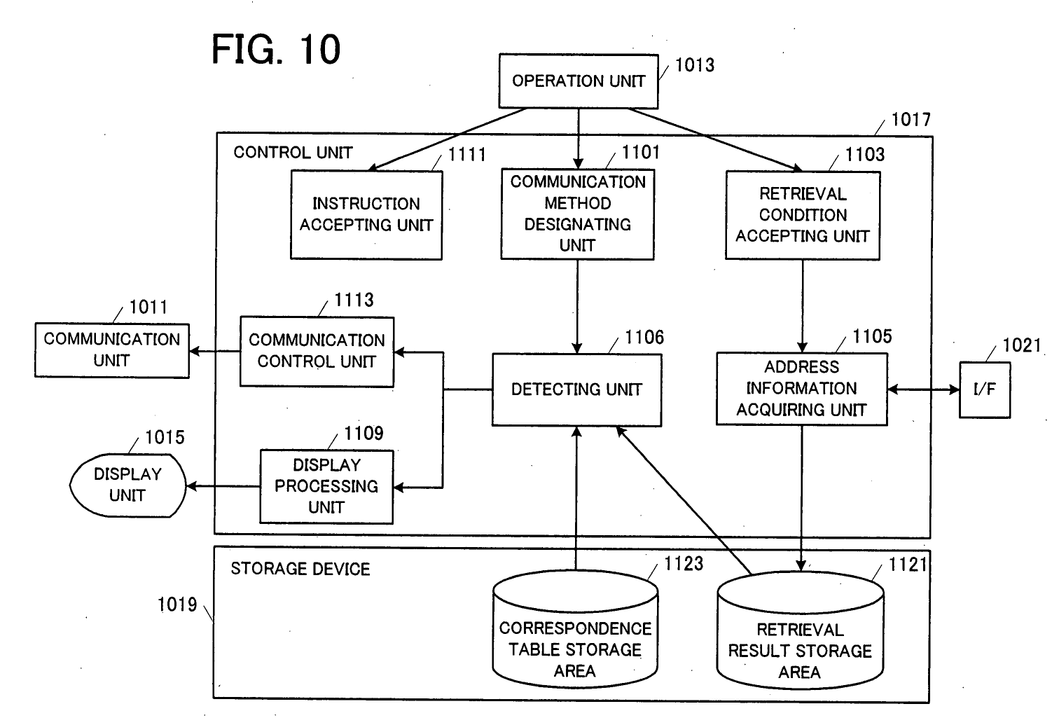

FIG. 10 is a functional block diagram showing details of the control unit 1017 of the communication terminal device 1010 of FIG. 9. The control unit 1017 includes a communication designating unit 1101, a retrieval condition accepting unit 1103, an address information acquiring unit 1105, a detecting unit 1106, a display processing unit 1109, an instruction accepting unit 1111 and a communication control unit 1113. The storage device 1019 includes a retrieval result storage area 1121 and a correspondence table storage area 1123.

The communication method designating unit 1101 designates a communication method for transmitting information. For example, when transmitting the information to the facsimile terminal 1031, the communication method designating unit 1101 designates facsimile communication using the PSTN as the communication method. When transmitting the information to the e-mail terminal 1033, the communication method designating unit 1101 designates e-mail communication as the communication method. When transmitting the information to the Internet facsimile terminal 1035, the communication method designating unit 1101 designates IP facsimile communication as the communication method.

The retrieval condition accepting unit 1103 accepts from the user, an input of the retrieval condition for inquiring the address information. Here, the retrieval condition is designated by inputting at least a part of a name or a department of a transmission destination from the operation unit 1013 by the user.

The address information acquiring unit 1105 inquires the directory server 1043, which has the database storing a plurality of address information, as to the address information in accordance with the retrieval condition. The address information acquiring unit 1105 acquires the address information of the retrieval result returned from the directory server 1043. The address information acquiring unit 1105 stores the acquired address information in the retrieval result storage area 1121 of the storage device 1019.

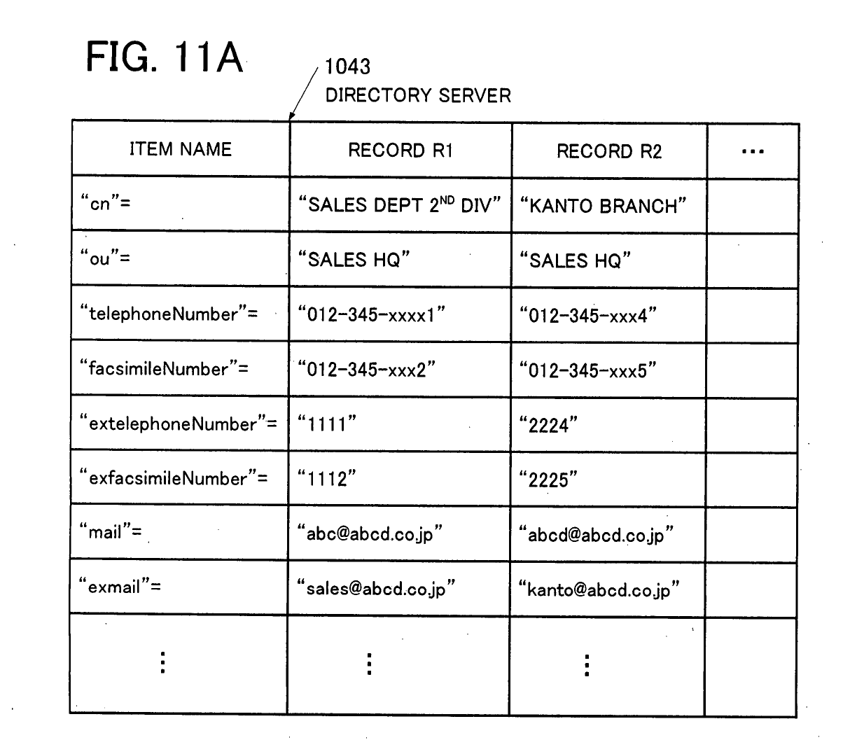

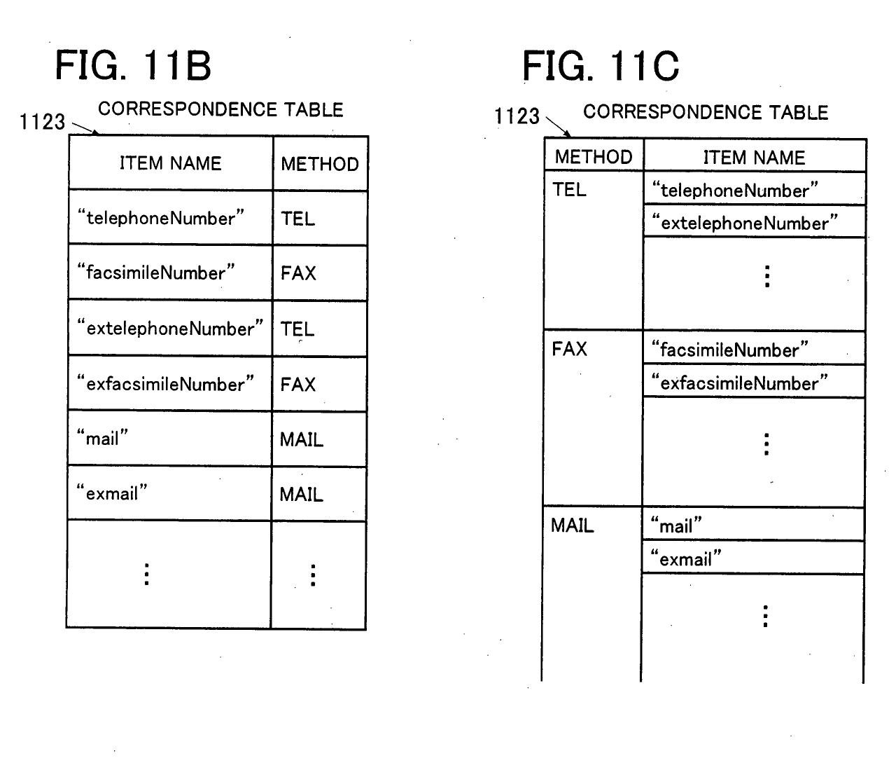

FIG. 11A shows a data structure of the database of the directory server 1043. The database includes a plurality of attributes associated to item names. Among the attributes, attributes which the item names are “cn”, “ou”, “telephoneNumber”, “facsimileNumber” and “mail” are basic attributes of any directory servers 1043. In the present embodiment, the directory server 1043 also includes attributes associated to extensive item names set by the manager. The extensive attributes are attributes which the item names “extelephoneNumber”, “exfacsimileNumber” and “exmail”.

As described above, the address information of the directory server 1043 includes a plurality of attributes. In the attributes, an extensive attribute which can be set independently at each directory server 1043 is included. Therefore, the communication terminal device 1010 cannot grasp which attribute is for which destination corresponding to which communication method with the attributes as it is. In the present embodiment, the correspondence table storage area 1123 stores a correspondence table associating the item name of the attribute of the address information and the communication method. Therefore, by referring to the correspondence table, the communication terminal device 1010 can grasp which attribute corresponds to which communication method.

FIG. 11B shows an example of a data structure of the correspondence table storage area 1123. Here, the item name of the attributes and the corresponding communication method are associated. For example, the item names “telephoneNumber” and “extelephoneNumber” are associated to a telephone “TEL”. The item names “facsimileNumber” and “exfacsimileNumber” are associated to a facsimile “FAX”. FIG. 11C shows another example of the data structure of the correspondence table storage area 1123. Here, the item names of the attributes and the corresponding communication methods are associated in the same manner.

Referring to FIG. 10 again, the detecting unit 1106 refers to the correspondence table storage area 1123 and detects an attribute which is to be the destination of the communication method from the attributes included in the address information stored in the retrieval result storage area 1121. For example, in case of a record R1 shown in FIG. 1A, “012-345-xxx1” and “1111” are detected as destinations of the telephone “TEL”. “012-345-xxx2” and “1112” are detected as destinations of the facsimile “FAX”.

The display processing unit 1109 carries out a process for displaying the detection result of the detecting unit 1106 on the display unit 1015.

The instruction accepting unit 1111 accepts various instructions from the user and notifies the accepted instruction to a corresponding unit. Further, in FIG. 10, a line indicating a notification of the instruction from the instruction accepting unit 1111 to each unit is omitted. In accordance with the instruction accepted by the instruction accepting unit 1111, the communication control unit 1113 controls the communication carried out by the communication unit 1011.

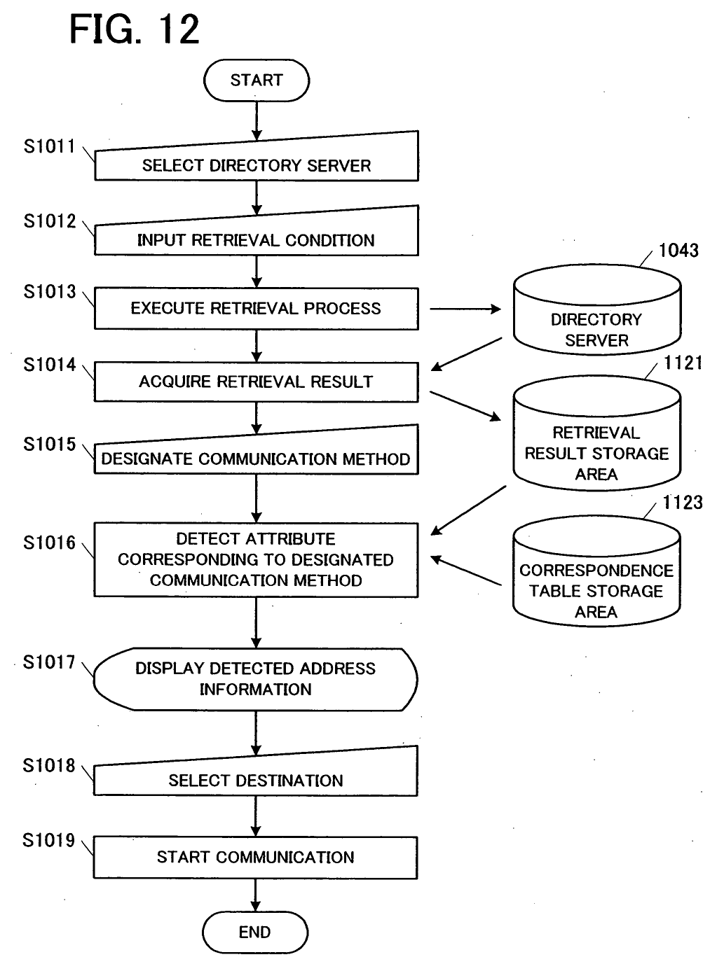

An operation of the above-described communication terminal device 1010 will be described. FIG. 12 is a flowchart showing the operation of the communication terminal device 1010.

First, at least one directory server for executing the retrieval process is selected (step S1011). The directory server can be selected by the user. However, this step can be omitted. For example, the directory server 1043 for executing the retrieval process can be set previously. An appropriate directory server 1043 can be selected automatically by the address information acquiring unit 1105. Alternatively, an inquiry can be carried out at the same time or sequentially to the plurality of the directory servers 1043.

Next, a retrieval condition is input (step S1012). For example, when the user inputs at least a part of a name of a transmission destination, the retrieval condition accepting unit 1103 accepts the input value as the retrieval condition.

Then, the retrieval process is executed (step S1013). The directory server 1043 retrieves the address information in accordance with the retrieval condition via the interface unit 1021. The address information acquiring unit 1105 acquires the retrieval result (step S1014). When the directory server 1043 carries out the retrieval process, the address information acquiring unit 1105 acquires the retrieval result from the directory server 1043 via the interface unit 1021. The address information acquiring unit 1105 stores the retrieval result in the retrieval result storage area 1121.

Next, the communication method designating unit 1101 designates at least one communication method for transmitting the information (step S1015). This process can be carried out before selecting the directory server at step S1011.

Next, the detecting unit 1106 refers to the correspondence table of the correspondence table storage area 1123 and detects the attribute corresponding to the destination of the communication method designated at step S1015 (step S1016). The display processing unit 1109 displays the extracted result on the display unit 1015 (step S1017).

Next, the address information of the destination is selected from the displayed retrieval result (step S1018). The user can refer to the result displayed on the display unit 1015 and select the address information of the destination. The instruction accepting unit 1111 accepts the selection made by the user and notifies the address information of the accepted destination to the communication control unit 1113. Then, when the user instructs the start of the communication, the communication starts (step S1019).

The process of step S1015 can be omitted. In this case, at step S1016, the detecting unit 1106 can detect all of the attributes which are to be the destination of any one of the communication methods.

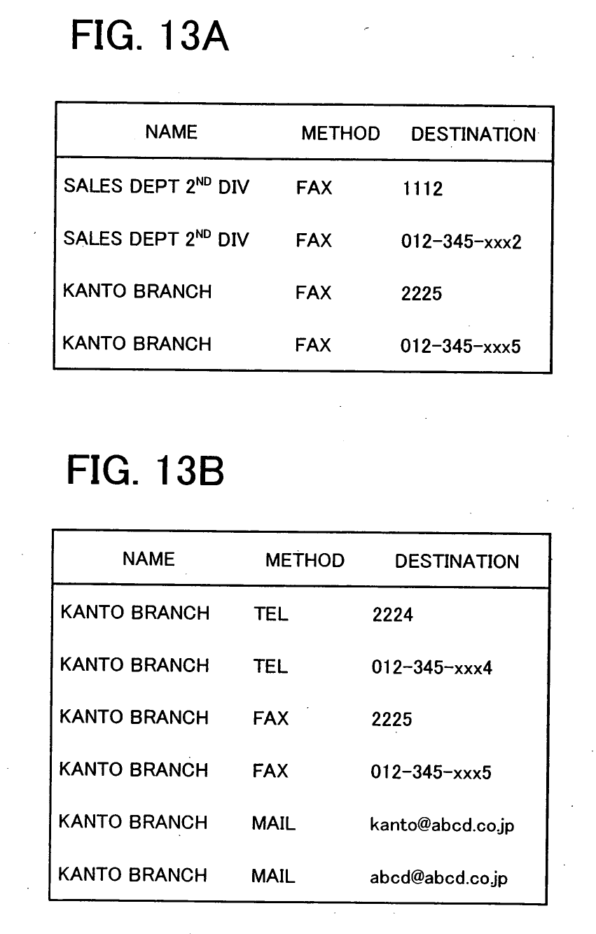

FIG. 13A and FIG. 13B show examples of the display at step S1017. FIG. 13A shows an example of a display when “SALES HQ” is input as the retrieval condition at step S1012 and the facsimile communication is designated as the communication method at step S1015.

When the address information acquiring unit 1105 acquires the retrieval result shown in FIG. 11A, the detecting unit 1106 refers to the correspondence table shown in FIG. 11B or FIG. 11C. The detecting unit 1106 detects the attribute associated to the communication method of FAX. The display processing unit 1109 displays the information of the attribute detected by the detecting unit 1106 on the display unit 1015.

FIG. 13B shows an example of a display when “KANTO” is input as the retrieval condition at step S1012 and the process of step S1015 is omitted. Here, the destinations are displayed for each of a plurality of communication methods, TEL, FAX and MAIL.

As described above, according to the communication terminal device 1010 of the present embodiment, a plurality of the attributes of the address information stored in the directory server 1043 can be associated to the communication method and notified to the user.

The correspondence table is previously stored in the correspondence table storage area 1123 by the user of the communication terminal device 1010. The correspondence table storage area 1123 can store the correspondence tables for each of the directory servers 1043 by associating to the identification information of each of the directory servers 1043. In this case, when acquiring the address information from each of the directory servers 1043, the address information acquiring unit 1105 can also acquire the identification information of the directory server 1043. The detecting unit 1106 can refer to the correspondence table with the identification information as the key and detect a destination.

The preferred embodiments of the present invention have been described. However, the present invention is not limited to the above-described embodiments. It is to be understood by those skilled in the art that there are variations to the present invention without departing from the scope of the present invention.

In the above-described embodiment, the detecting unit 1106 refers to the correspondence table storage area 1123 and detects a destination from the attributes included in the address information. However, as another example, the detecting unit 1106 can detect a destination in accordance with a character string included in the item name associated to the attribute. For example, the detecting unit 1106 can detect the attribute associated to the item name including the character string “telephone” as a destination of the telephone.

In this case, the detecting unit 1106 inquires to the user and after obtaining a confirmation of the user, the result can be stored newly in the correspondence table storage area 1123. Accordingly, from the next time, the detecting unit 1106 can refer to the correspondence table storage area 1123 and detect that the attribute is the destination of the telephone.

As described above, even if the attribute is an attribute set randomly at the directory server 1043, the communication terminal device 1010 can detect the attribute by associating to the communication method. Even with respect to the retrieval result from the directory server 1043 with unknown data structure, the destination can be managed for each communication method.

In the above-described embodiments, as the communication methods, the telephone or the facsimile communication using the PSTN, the e-mail communication and the telephone or the facsimile communication using the Internet are shown. As the communication methods, an access to a URL, an access to an FTP server and an access to a shared folder or the like can also be included.

The communication terminal device according to the present invention has an effect that the address information acquired from the directory server can be utilized effectively. The communication terminal device according to the present invention is useful as a communication terminal device which carries out communication by acquiring the address information from a remote database.

The communication terminal device according to the present invention has an effect that by using both of the information stored in the directory server and the communication terminal device, the address information can be acquired efficiently. The communication terminal device according to the present invention is useful as a communication terminal device which carries out communication by acquiring the address information by using the directory service.

1. A communication terminal device comprising:
means for storing address information;
means for accepting a retrieval condition for inquiring the address information;
means for acquiring from a directory server having a database in which the address information is stored, address information retrieved in accordance with the retrieval condition;
means for retrieving from the address information stored in the means for storing, address information corresponding to the retrieval condition; and
means for notifying at the same time, the address information acquired by the means for acquiring and the address information detected by the means for retrieving.

2. The communication terminal device according to claim 1, wherein the means for acquiring acquires the address information by associating to identification information which specifies the directory server that provided the address information, and the means for notifying notifies the address information and the identification information indicating a provider of each address information.

3. The communication terminal device according to claim 1, further comprising:
means for selecting at least one directory server to be retrieved from a plurality of directory servers.

4. The communication terminal device according to claim 1, further comprising:
means for detecting a degree of reliability of the address information acquired by the means for acquiring and the address information detected by the means for retrieving;
wherein the means for notifying notifies the address information and the degree of reliability.

5. The communication terminal device according to claim 4, wherein the means for detecting detects the degree of reliability in accordance with a communication result.

6. The communication terminal device according to claim 4, wherein when notifying a plurality of address information, the means for notifying notifies the address information in an order based on the degree of reliability detected by the means for detecting.

7. A communication terminal device which carries out communication under a plurality of communication methods, the communication terminal device comprising:
means for accepting a retrieval condition;
means for acquiring from a database which stores address information including a plurality of attributes and item names of the attributes by associating to one another, address information retrieved in accordance with the retrieval condition and an item name;
means for detecting from the plurality of the attributes in accordance with the item name, an attribute corresponding to a destination of the communication by a communication method; and
means for notifying the attribute detected by the means for detecting and the address information by associating the attribute to the communication method.

8. The communication terminal device according to claim 7, wherein the attribute is one of a telephone number, a facsimile number and an electronic mail address.

9. The communication terminal device according to claim 7, further comprising:
means for storing the communication methods and the item names of the attributes by associating to one another;
wherein the means for detecting refers to the means for storing and detects the attribute corresponding to a destination of the communication by the communication method from the plurality of the attributes.

10. The communication terminal device according to claim 7, wherein the means for detecting detects the attribute corresponding to the destination of the communication by the communication method from the plurality of the attributes in accordance with a feature of the item name acquired by the means for acquiring.

11. The communication terminal device according to claim 7, wherein the item name stored in the database is set randomly by a manager of the database.

12. An address information notifying method in a communication device, comprising the steps of:
accepting a retrieval condition for inquiring address information;
acquiring from a directory server having a database storing the address information, address information retrieved in accordance with the retrieval condition;
detecting from the address information stored in a storage unit, address information corresponding to the retrieval condition; and
notifying at the same time, the acquired address information and the detected address information.

13. An address information notifying method in a communication terminal device which can carry out communication by a plurality of communication methods, the method comprising the steps of:
accepting a retrieval condition;
acquiring from a database which stores address information including a plurality of attributes and item names of the attributes by associating to one another, address information retrieved in accordance with the retrieval condition and an item name;
detecting from the plurality of the attributes in accordance with the item name, an attribute corresponding to a destination of the communication by a communication method; and
notifying the detected attribute and the address information by associating the attribute to the communication method.

14. The communication terminal device according to claim 1, wherein the means for acquiring acquires the address information by associating to identification information which specifies the directory server that provided the address information.

15. The communication terminal device according to claim 1, wherein the means for notifies the address information and the identification information indicating a provider of each address information.
